(19) United States
(12) Patent Application Publication
(10) Pub. No.: US 2015/0317426 A1
(43) Pub. Date: Nov. 5, 2015

(54) DATA PATH SYSTEM ON CHIP DESIGN METHODOLOGY

(71) Applicant: QUALCOMM Incorporated, San Diego, CA (US)

(72) Inventors: Stanley Seungchul SONG, San Diego, CA (US); Niladri Narayan MOJUMDER, San Diego, CA (US); Zhongze WANG, San Diego, CA (US); Choh Fei YEAP, San Diego, CA (US)

(21) Appl. No.: 14/498,939

(22) Filed: Sep. 26, 2014

Related U.S. Application Data
(60) Provisional application No. 61/988,856, filed on May 5, 2014.

(51) Int. Cl. G06F 17/50

(52) U.S. Cl. CPC G06F 17/5081

(57) ABSTRACT

Integrated circuit (IC) technology design may include binning data paths of an IC device of a current technology node to bins based on a performance of each of the data paths. Each of the plurality of bins is mapped to a representative circuit unit data path configured according to a predetermined set of electrical and/or physical parameters. The representative circuit unit data paths are calibrated according to updated electrical and/or physical parameters to increase the performance of the representative circuit unit data paths to improve the performance of the IC device in an advanced technology node.

### CROSS REFERENCE TO RELATED APPLICATION

This application claims the benefit under 35 U.S.C. §119(e) to U.S. Provisional Patent Application No. 61/988,856, entitled “DATA PATH SYSTEM ON CHIP DESIGN METHODOLOGY,” filed on May 5, 2014, the disclosure of which is expressly incorporated by reference herein in its entirety.

### BACKGROUND

1. Field

Aspects of the present disclosure relate to semiconductor devices, and more particularly to overall system design considerations for system on chip (SOC) technology.

2. Background

The use of semiconductor materials for electronic devices is widespread. Many different materials, such as silicon (Si), gallium arsenide (GaAs), and other compound semiconductor materials may create various types of devices, such as light emitting diodes, transistors, solar cells, and may also create integrated circuits including a large number of individual devices.

Because the functionality of many devices has become more complicated, rather than integrate discrete components on a printed circuit board, many approaches integrate the semiconductor components on a single chip or die. Such integrations may be known as “system on chip” (SOC) designs.

### SUMMARY

A method of integrated circuit (IC) technology design may include binning data paths of an IC device of a current technology node to bins based on a performance of each of the data paths. Each of the bins is mapped to one representative circuit unit data path configured according to a predetermined set of electrical and/or physical parameters. The representative circuit unit data paths are calibrated according to updated electrical and/or physical parameters to increase the performance of the representative circuit unit data paths to improve the performance of the IC device in an advanced technology node.

A device for designing an integrated circuit (IC) in accordance with another aspect of the present disclosure may include means for binning data paths of an IC device of a current technology node to bins based at least in part on a performance of each of the data paths. Such a device may also include means for mapping each of the bins to a representative circuit unit data path configured according to a predetermined set of electrical and/or physical parameters. Such a device further includes means for calibrating the set of representative circuit unit data paths according to updated electrical and/or physical parameters to increase the performance of the set of representative circuit unit data paths to improve the performance of the IC device of an advanced technology node.

A device for designing an integrated circuit (IC) in accordance with another aspect of the present disclosure includes a memory and a processor coupled to the memory. The processor(s) is configured to bin data paths of an IC device of a current technology node to bins based at least in part on a performance of each of the data paths. The processor is also configured to map each of the bins to a representative circuit unit data path configured according to a predetermined set of electrical and/or physical parameters. The processor may also be configured to calibrate the set of representative circuit unit data paths according to updated electrical and/or physical parameters to improve the performance of the set of representative circuit unit data paths to improve the performance of the IC device of an advanced technology node.

A computer program product configured to design an integrated circuit (IC) includes a non-transitory computer-readable medium having non-transitory program code recorded thereon. The non-transitory program code includes program code to bin data paths of an IC device of a current technology node to bins based at least in part on a performance of each of the data paths. The non-transitory program code may also include program code to map each of the bins to a representative circuit unit data path configured according to a predetermined set of electrical and/or physical parameters. The non-transitory program code may also include program code to calibrate the set of representative circuit unit data paths according to updated electrical and/or physical parameters to optimize the performance of the set of representative circuit unit data paths to improve the performance of the IC device of an advanced technology node.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates a perspective view of a semiconductor wafer in an aspect of the present disclosure.

FIG. 2 illustrates a cross-sectional view of a die in accordance with an aspect of the present disclosure.

FIG. 3 illustrates a cross-sectional view of a metal-oxide-semiconductor field-effect transistor (MOSFET) device in an aspect of the present disclosure.

FIG. 4 illustrates a transistor in accordance with an aspect of the present disclosure.

FIG. 5 illustrates a block diagram approach to system on chip (SOC) design in an aspect of the present disclosure.

FIG. 6 illustrates a block diagram approach to SOC design in accordance with another aspect of the present disclosure.

FIGS. 7A-7B illustrate a graphical approach to an aspect of the present disclosure.

FIGS. 8A-8B illustrate a graphical approach to an aspect of the present disclosure.

FIG. 9 illustrates a system on chip model in accordance with an aspect of the present disclosure.

FIG. 10 illustrates a process flow diagram in accordance with an aspect of the present disclosure.

FIG. 11 is a process flow diagram illustrating a method for fabricating a device on a semiconductor substrate according to an aspect of the present disclosure.

FIG. 12 is a block diagram showing an exemplary wireless communication system in which a configuration of the disclosure may be advantageously employed.

FIG. 13 is a block diagram illustrating a design workstation used for circuit, layout, and logic design of a semiconductor component according to one configuration.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In related system on chip (SOC) designs, the various portions of the system (e.g., the modem portion, the central processing unit (CPU) portion, the digital signal processor (DSP) portion, etc.) are designed and performance-tuned separately from each other. As such, a better performing overall system design is generally not contemplated in current SOC designs.

One aspect of the present disclosure describes methods and approaches to take a representative sample of path delay values (not just critical paths) of an IC device of a current technology node. The representative sample of path delay values may include substantially all or all of the path delay values for a given SOC of the current technology node. Each bin may have an initial set of electrical and/or physical parameters based on performance of each of the data paths. In this aspect of the disclosure, similar path delay values from the representative sample of path delay values are combined (“binned”) into groups. These binned path delay values are then mapped into a representative circuit unit (e.g., based on the delay values and/or power usage for each bin). One aspect of the present disclosure calculates updated electrical and/or physical parameters based on the representative circuit units to improve performance of an IC device of an advanced technology node.

For example, an SOC of the advanced technology node is designed using new maps produced according to a different threshold voltage/gate (or channel) length (Vt/Lg) for each of the binned values. The mapping may indicate the more critical paths in the SOC. Such an approach may be referred to as a “critical path aware (CPA)” approach. By using binning and mapping of the path delays (BMP) of the IC device of the current technology node for the SOC design, the design increases the performance of the overall SOC. The performance of the overall SOC is improved by calculating updated electrical and/or physical parameters for the advanced technology node, rather than focusing on individual portions of the SOC during the design and analysis portions of fabrication.

In addition, design parameters other than the path may be considered. The other design parameters may include, but are not limited to, transistor current ON-current OFF (Ion-Ioff) slope and shift, parasitic resistance-capacitance (RC), power usage, or other like design criteria to increase the performance of the SOC. This aspect of the present disclosure allows for both back-end-of-line (BEOL) and front-end-of-line (FEOL) increases in performance within the SOC.

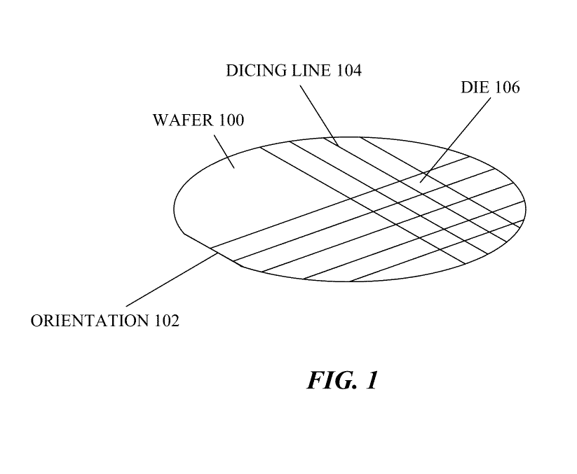

FIG. 1 illustrates a perspective view of a wafer in an aspect of the present disclosure. The wafer 100 may be a semiconductor wafer, or may be a substrate material with one or more layers of semiconductor material on a surface of the wafer 100. When the wafer 100 is a semiconductor material, it may be grown from a seed crystal using the Czochralski process, where the seed crystal is dipped into a molten bath of semiconductor material and slowly rotated and removed from the bath. The molten material then crystalizes onto the seed crystal in the orientation of the crystal.

The wafer 100 may be made from a compound material, such as gallium arsenide (GaAs), gallium nitride (GaN), a ternary material such as indium gallium arsenide (InGaAs), quaternary materials, or any material that can be used as a substrate material for other semiconductor materials. Although many of the materials may be crystalline in nature, polycrystalline or amorphous materials may also be used for the wafer 100.

The wafer 100, or layers that are coupled to the wafer 100, may be supplied with materials that make the wafer 100 more conductive. For example, and not by way of limitation, a silicon wafer may have phosphorus or boron added to the wafer 100 to allow for electrical charge to flow in the wafer 100. These additives are referred to as dopants, and are used to provide extra charge carriers (either electrons or holes) within the wafer 100 or portions of the wafer 100. By selecting the areas where the extra charge carriers are provided, which type of charge carriers are provided, and the amount (density) of additional charge carriers in the wafer 100, different types of electronic devices may be formed in or on the wafer 100.

The wafer 100 has an orientation 102 that indicates the crystalline orientation of the wafer 100. The orientation 102 may be a flat edge of the wafer 100 as shown in FIG. 1, or may be a notch or other indicia to illustrate the crystalline orientation of the wafer 100. The orientation 102 may indicate the Miller Indices for the planes of the crystal lattice in the wafer 100.

The Miller indices form a notation system of the crystallographic planes in crystal lattices. The lattice planes may be indicated by three integers h, k, and l, which are the Miller indices for a plane (hkl) in the crystal. Each index denotes a plane orthogonal to a direction (h, k, l) in the basis of the reciprocal lattice vectors. The integers are usually written in lowest terms (i.e., their greatest common divisor should be 1). Miller index 100 represents a plane orthogonal to direction h; index 010 represents a plane orthogonal to direction k, and index 001 represents a plane orthogonal to l. For some crystals, negative numbers are used (written as a bar over the index number) and for some crystals, such as gallium nitride, more than three numbers may be needed to adequately describe the different crystallographic planes.

Once the wafer 100 has been processed as desired, the wafer 100 is divided up using dicing lines 104. The wafer 100 may be sawn or otherwise separated into pieces to form the die 106. Each of the die 106 may be an integrated circuit with many devices or may be a single electronic device. The physical size of the die 106, which may also be referred to as a chip, may depend on the ability to separate the wafer 100 into certain sizes, as well as the number of individual devices that the die 106 is designed to contain.

Once the wafer 100 has been separated into one or more die 106, the die 106 may be mounted into packaging to allow access to the devices and/or integrated circuits fabricated on the die 106. Packaging may include single in-line packaging, dual in-line packaging, motherboard packaging, flip-chip packaging, indium dot/bump packaging, or other types of devices that access the die 106. The die 106 may also be directly accessed through wire bonding, probes, or other connections without mounting the die 106 into a separate package.

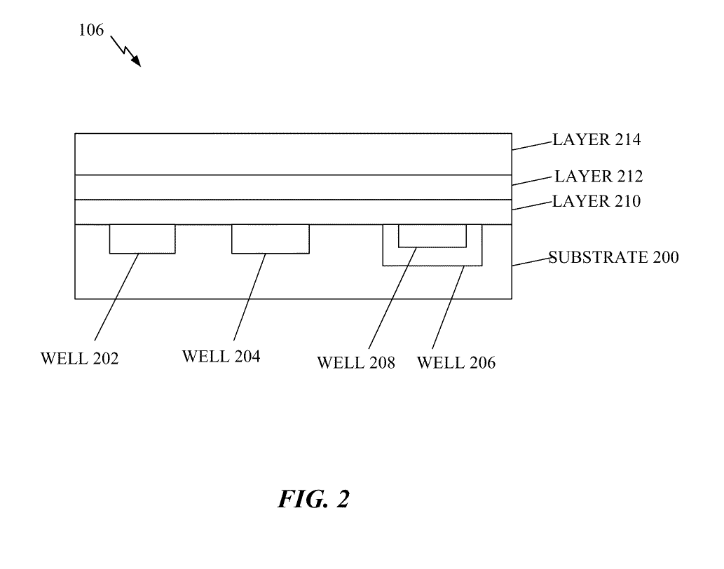

FIG. 2 illustrates a cross-sectional view of a die in accordance with an aspect of the present disclosure. In the die 106, there may be a substrate 200, which may be a semiconductor material and/or may act as a mechanical support for the electronic devices. The substrate 200 may be a doped semiconductor substrate, which has either electrons (designated n-type) or holes (designated p-type) charge carriers present throughout the substrate 200. Subsequent doping of the substrate 200 with charge carrier ions/atoms may change the charge carrying capabilities of the substrate 200.

Within a substrate 200, there may be wells 202 and 204, which may be the source and/or drain of a field-effect transistor (FET), or wells 202 and/or 204 may be the fin structures of a fin structured FET (FinFET). Wells 202 and/or 204 may also be other devices (e.g., a resistor, a capacitor, a diode, or other electronic devices) depending on the structure and other characteristics of the wells 202 and/or 204 and the surrounding structure of the substrate 200.

The semiconductor substrate may also have a well 206 and a well 208. The well 208 may be completely within the well 206, and, in some cases, may form a bipolar junction transistor (BJT). The well 206 may also be used as an isolation well to isolate the well 208 from electric and/or magnetic fields within the die 106.

A first layer 210, a second layer 212 and a third layer 214 may also be added to the die 106. The first layer 210 may be, for example, an oxide or insulating layer that may isolate the wells 202-208 from each other or from other devices on the die 106. In such cases, the first layer 210 may be silicon dioxide, a polymer, a dielectric, or another electrically insulating layer. The first layer 210 may also be an interconnection layer, in which case it may comprise a conductive material such as copper, tungsten, aluminum, an alloy, or other conductive or metallic materials.

The second layer 212 may also be a dielectric or conductive layer, depending on the desired device characteristics and/or the materials used for the first layer 210, the second layer 212 and the third layer 214. The third layer 214 may be an encapsulating layer, which may protect the first layer 210 and the second layer 212, as well as the wells 202-208 and the substrate 200, from external forces. For example, and not by way of limitation, the third layer 214 may be a layer that protects the die 106 from mechanical damage, or the third layer 214 may be a layer of material that protects the die 106 from electromagnetic or radiation damage.

Electronic devices designed on the die 106 may comprise many features or structural components. For example, the die 106 may be exposed to any number of methods to impart dopants into the substrate 200, the wells 202-208, and, if desired, the first layer 210, the second layer 212 and the third layer 214. For example, and not by way of limitation, the die 106 may be exposed to ion implantation, deposition of dopant atoms that are driven into a crystalline lattice through a diffusion process, chemical vapor deposition, epitaxial growth, or other methods. Through selective growth, material selection, and removal of portions of the first layer 210, the second layer 212 and the third layer 214, and through selective removal, material selection, and dopant concentration of the substrate 200 and the wells 202-208, many different structures and electronic devices may be formed within the scope of the present disclosure.

Further, the substrate 200, the wells 202-208, and the first layer 210, the second layer 212 and the third layer 214 may be selectively removed or added through various processes. Chemical wet etching, chemical mechanical planarization (CMP), plasma etching, photoresist masking, damascene processes, and other methods may create the structures and devices of the various aspects of the present disclosure.

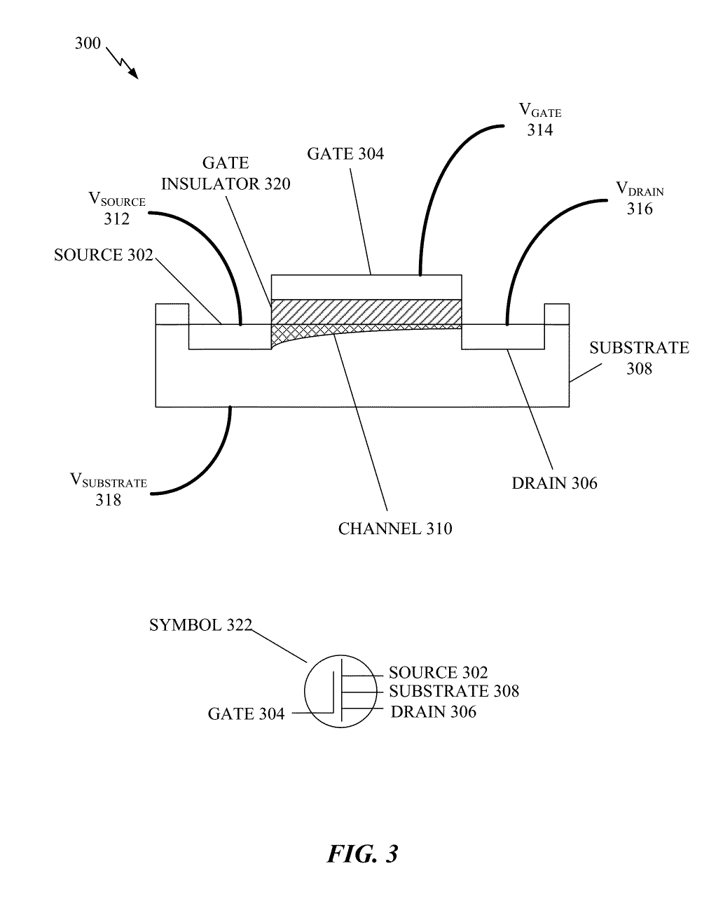

FIG. 3 illustrates a cross-sectional view of a metal-oxide-semiconductor field-effect transistor (MOSFET) device in an aspect of the present disclosure. A metal-oxide-semiconductor field-effect transistor (MOSFET) 300 may have four input terminals. The four inputs are a source 302, a gate 304, a drain 306, and a substrate 308. The source 302 and the drain 306 may be fabricated as the wells 202 and 204 in the substrate 308, or may be fabricated as areas above the substrate 308, or as part of other layers on the die 106 if desired. Such other structures may be a fin or other structure that protrudes from a surface of the substrate 308. Further, substrate 308 may be the substrate 200 on the die 106, but substrate 308 may also be one or more of the first layer 210, the second layer 212 and the third layer 214 that are coupled to the substrate 200.

The MOSFET 300 is a unipolar device, as electrical current is produced by only one type of charge carrier (i.e., either electrons or holes depending on the type of MOSFET). The MOSFET 300 may operate by controlling the amount of charge carriers in the channel 310 between the source 302 and the drain 306. A Vsource 312 voltage is applied to the source 302, a Vgate 314 voltage is applied to the gate 304, and a Vdrain 316 voltage is applied to the drain 306. A Vsubstrate 318 voltage may also be applied to the substrate 308, although the Vsubstrate 318 voltage may be coupled to one of the other voltages (e.g., Vsource 312, Vgate 314 or Vdrain 316).

To control the charge carriers in the channel 310, the Vgate 314 creates an electric field in the channel 310 when the gate 304 accumulates charges. The opposite charge to that accumulating on the gate 304 begins to accumulate in the channel 310. The gate insulator 320 insulates the charges accumulating on the gate 304 from the source 302, the drain 306, and the channel 310. The gate 304 and the channel 310 create a capacitor, and as the Vgate 314 increases, eventually enough accumulated charges occur in the channel 310 to provide an electrically conductive path between the source 302 and the drain 306. This condition may be referred to as opening the channel of the FET.

By changing the Vsource 312 and the Vdrain 316 voltages, and their relationship to the Vgate 314, the amount of voltage used on the gate 304 to open the channel may vary. For example, the Vsource 312 voltage is usually of a higher potential than that of the Vdrain 316. Making the voltage differential between the Vsource 312 and the Vdrain 316 larger will change the amount of the Vgate 314 used to open the channel 310. Further, a larger voltage differential will change the amount of electromotive force moving charge carriers through the channel, creating a larger current through the channel 310.

The gate insulator 320 material may be silicon oxide, or may be a dielectric or other material with a different dielectric constant (k) than silicon oxide. Further, the gate insulator 320 may be a combination of materials or different layers of materials. For example, the gate insulator 320 may be Aluminum Oxide, Hafnium Oxide, Hafnium Oxide Nitride, Zirconium Oxide, or laminates and/or alloys of these materials. Other materials for the gate insulator 320 may be used without departing from the scope of the present disclosure.

By changing the material used for the gate insulator 320, and the thickness of the gate insulator 320 (i.e., the distance between the gate 304 and the channel 310), the amount of charge on the gate 304 used to open the channel 310 may vary. A symbol 322 showing the terminals of the MOSFET 300 is also illustrated. For n-type MOSFETs (using electrons as charge carriers in the channel 310), an arrow is applied to the substrate 308 terminal in the symbol 322 pointing away from the gate 304 terminal. For p-type MOSFETs (using holes as charge carriers in the channel 310), an arrow is applied to the substrate 308 terminal in the symbol 322 pointing toward the gate 304 terminal.

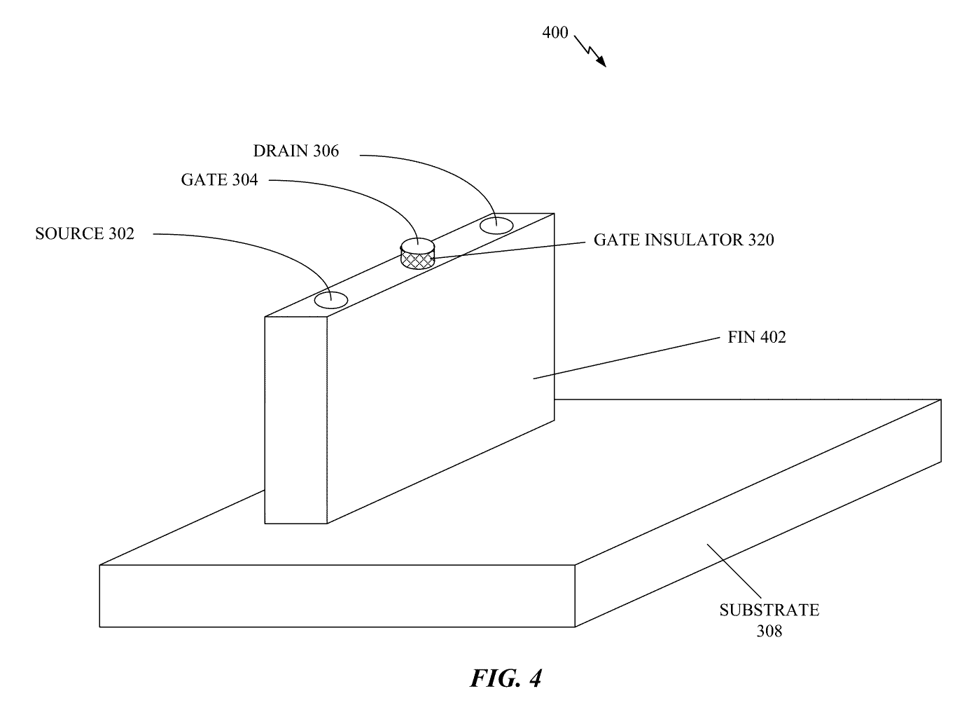

FIG. 4 illustrates a transistor in accordance with an aspect of the present disclosure. A fin-structured FET (FinFET) 400 operates in a similar fashion to the MOSFET 300 described with respect to FIG. 3. However, a fin 402 in a FinFET 400 is grown or otherwise coupled to the substrate 308. The fin 402 includes the source 302, the gate 304, and the drain 306. The gate 304 is coupled to the fin 402 through the gate insulator 320. In a FinFET structure, the physical size of the FinFET 400 may be smaller than the MOSFET 300 structure shown in FIG. 3. This reduction in physical size allows for more devices per unit area on the die 106.

### OVERALL SYSTEM ON CHIP (SOC) DESIGN PHILOSOPHY

In related SOC designs, the various portions of the system (e.g., the modem portion, the central processing unit (CPU) portion, the digital signal processor (DSP) portion, etc.) are designed and performance-tuned separately from each other. As such, a better performing overall system design is generally not contemplated in current SOC designs.

For example, during analysis/evaluation of the overall SOC design, related approaches may measure one threshold voltage (Vt) and one gate (channel) length (Lg) at a time for the entire SOC. Unfortunately, the overall Vt and Lg design “flavor” determined after repeating this process for the various measurements of Vt/Lg pairs throughout the SOC circuitry may not produce increased efficiency, performance and power usage for a SOC that has multiple speed and power operating conditions.

One aspect of the present disclosure describes methods and approaches to take a representative sample of path delay values (not just critical paths) of an IC device of a current technology node. The representative sample of path delay values may include substantially all or all of the path delay values for a given SOC of the current technology node. In this aspect of the disclosure, data paths with similar performance values (e.g., delay values) from the representative sample of path delay values are combined (“binned”) into groups. These binned data paths are then mapped into a representative circuit unit data path (e.g., based on the delay values and/or power usage for each bin). In one configuration, each of bins is mapped to a representative circuit unit data path configured according to a predetermined set of electrical and/or physical parameters. One aspect of the present disclosure calibrates a set of representative circuit unit data paths according to updated electrical and/or physical parameters to increase the performance of the set of representative circuit unit data paths. The updated electrical and/or physical parameters of the set of representative circuit unit data path may be used to improve performance of an IC device of an advanced technology node.

For example, an SOC of the advanced technology node is designed using new maps produced according to a different threshold voltage/gate (or channel) length (Vt/Lg) for each of the binned values. The mapping may indicate the more critical paths in the SOC. Such an approach may be referred to as a “critical path aware (CPA)” approach. By using binning and mapping of the path delays (BMP) of the IC device of the current technology node for the SOC design, the design increases the performance of the overall SOC. The performance of the overall SOC is improved by calculating updated electrical and/or physical parameters for the advanced technology node, rather than focusing on individual portions of the SOC during the design and analysis portions of fabrication.

In addition, design parameters other than the path may be considered. The other design parameters may include, but are not limited to, transistor current ON-current OFF (Ion-Ioff) slope and shift, parasitic resistance-capacitance (RC), power usage, or other like design criteria to increase the performance of the SOC. This aspect of the present disclosure allows for both back-end-of-line (BEOL) and front-end-of-line (FEOL) increases in performance within the SOC.

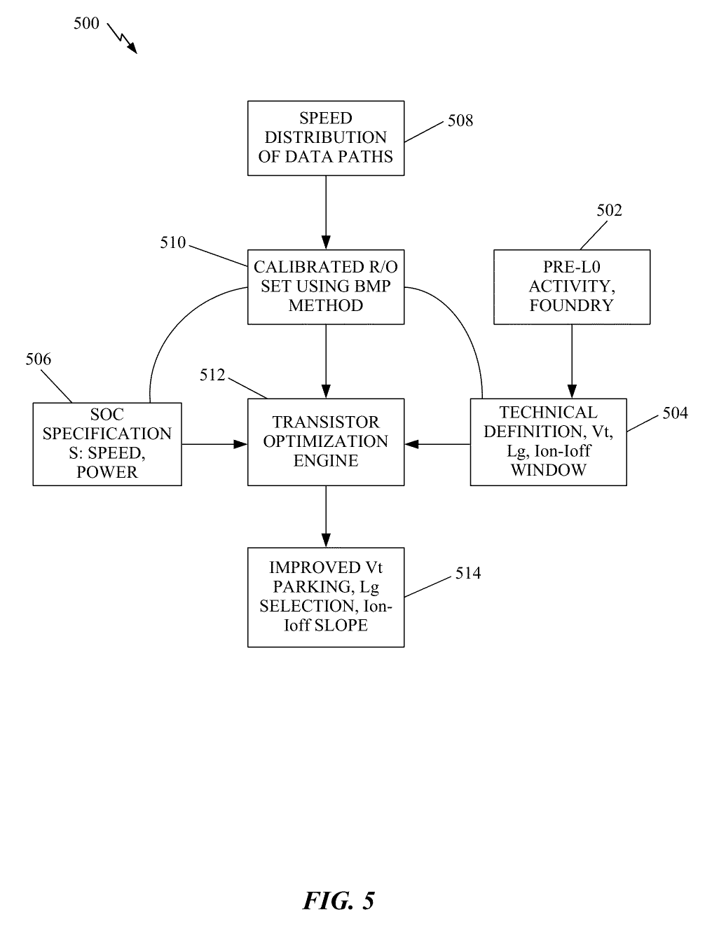

FIG. 5 illustrates a block diagram of an approach to SOC design in accordance with an aspect of the present disclosure. Diagram 500 illustrates foundry inputs 502 that may determine a technical definition 504. The foundry inputs 502 and the technical definition 504 may determine possible technologies (e.g., 20 nm designs, silicon-germanium (SiGe) designs, etc.) for the threshold voltages and gate lengths, on and off currents, and other parameters to design the overall SOC. In addition, the specifications 506 for the system, such as speed, power requirements, and other parameters, define the overall possibilities for the SOC design.

In an aspect of the present disclosure, some technology nodes may be more defined than others. As an example, a technology node that has been used for several years has been refined, studied, and analyzed such that the characteristics of that technology node are well known and can be precisely simulated on a computer. For a newer technology node, or an advanced technology node, this aspect of the present disclosure allows the analysis from other technology nodes to be applied to the advanced technology node to improve performance of the SOC being designed in the new or advanced technology node.

One aspect of the present disclosure also allows for changes in the technology node, or in the advanced technology node, to increase the performance or decrease the cost of production of the IC device and/or SOC. For example, this aspect of the present disclosure allows for changes or even optimization of the design for various parameters, such as device speed, device power consumption, device area scaling complexity, device die size, and/or a number of masks used to create the SOC.

An aspect of the present disclosure considers the data paths that run through the SOC and divides the data paths (e.g., or a representative sample of the data paths) by the length of time taken to traverse the data paths. The speed distribution 508 of the data paths for the SOC, along with the specifications 506 and the technical definition 504, are inputs to a set of devices. These devices (e.g., ring oscillators, logic gates, or other like devices) are binned and mapped by path (BMP) for a selected threshold voltage and gate length in block 510.

Once the power and/or speed for the data paths in the SOC are calibrated to a given part (e.g., ring oscillator, logic gate, etc.), the transistor optimization engine 512 determines which transistors, and/or which data paths, within the SOC may use different threshold voltages, gate lengths, transistor on/off currents, and other parameters and outputs a higher-performance SOC design as design output 514.

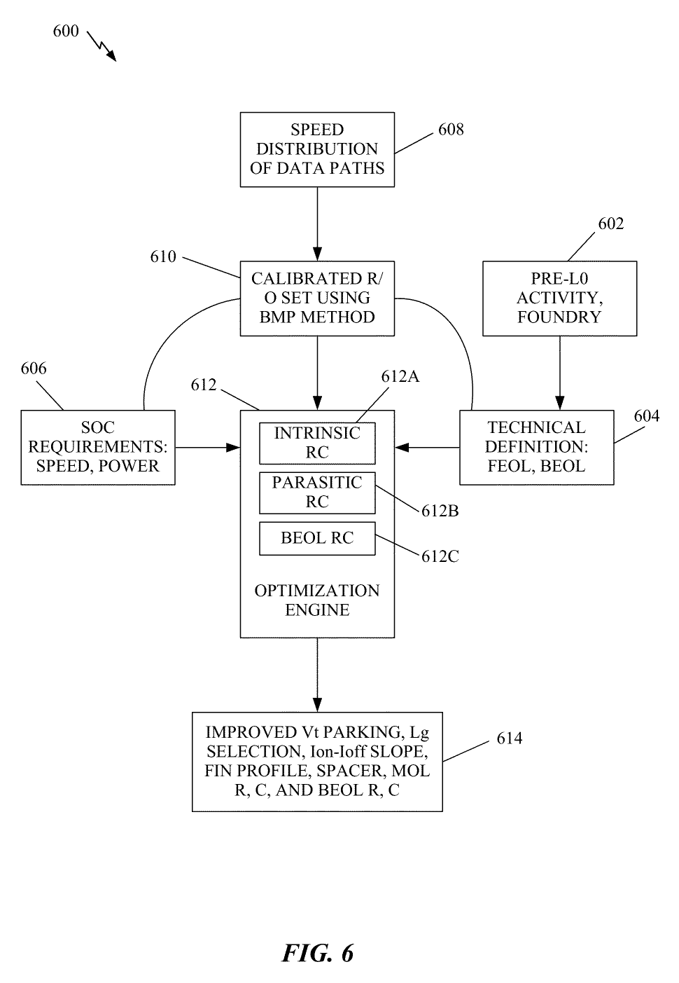

FIG. 6 illustrates a block diagram approach to SOC design in accordance with another aspect of the present disclosure. In a similar fashion to that shown in FIG. 5, the diagram 600 of FIG. 6 illustrates foundry inputs 602 that may determine a technical definition 604. The foundry inputs 602 and technical definition 604 may determine possible front end of line/back end of line (FEOL/BEOL) technologies that may design the overall SOC. In addition, the overall requirements 606 for the system, such as speed, power requirements, and other parameters, define the overall possibilities for the SOC design.

This aspect of the present disclosure sorts the data paths by a speed distribution 608 of the data paths for the SOC. The speed distribution 608, the overall requirements 606, and the technical definition 604, are inputs to a set of devices. These devices, which may be ring oscillators, logic gates, or other devices, are binned and mapped by path (BMP) for selected parameters in block 610.

Once the power and/or speed for the data paths in the SOC are calibrated to a given part (e.g., ring oscillator, logic gate, etc.), the optimization engine 612, which may contain components 612A, 612B, and 612C, fabricate a higher-performance SOC design as design output 614 by determining the different parameters used by the transistors and/or which data paths within the SOC. The different parameters may include, but are not limited to, threshold voltages, gate lengths, transistor on/off currents, fin profiles, spacer profiles, and resistance and capacitance values, and other like parameters.

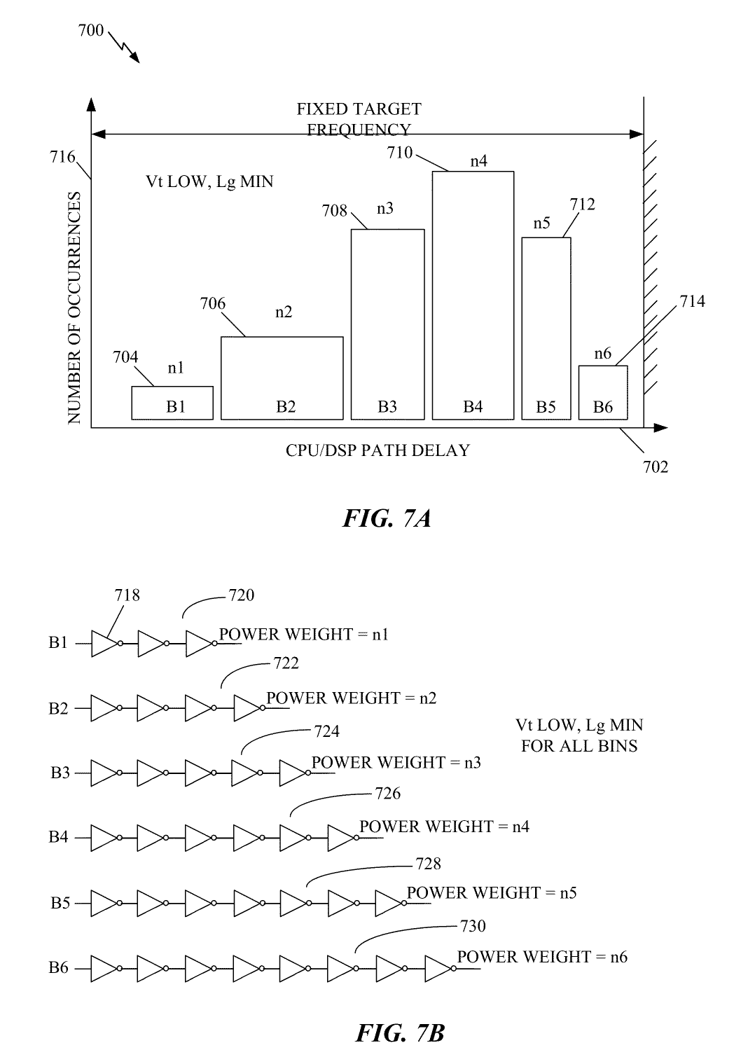

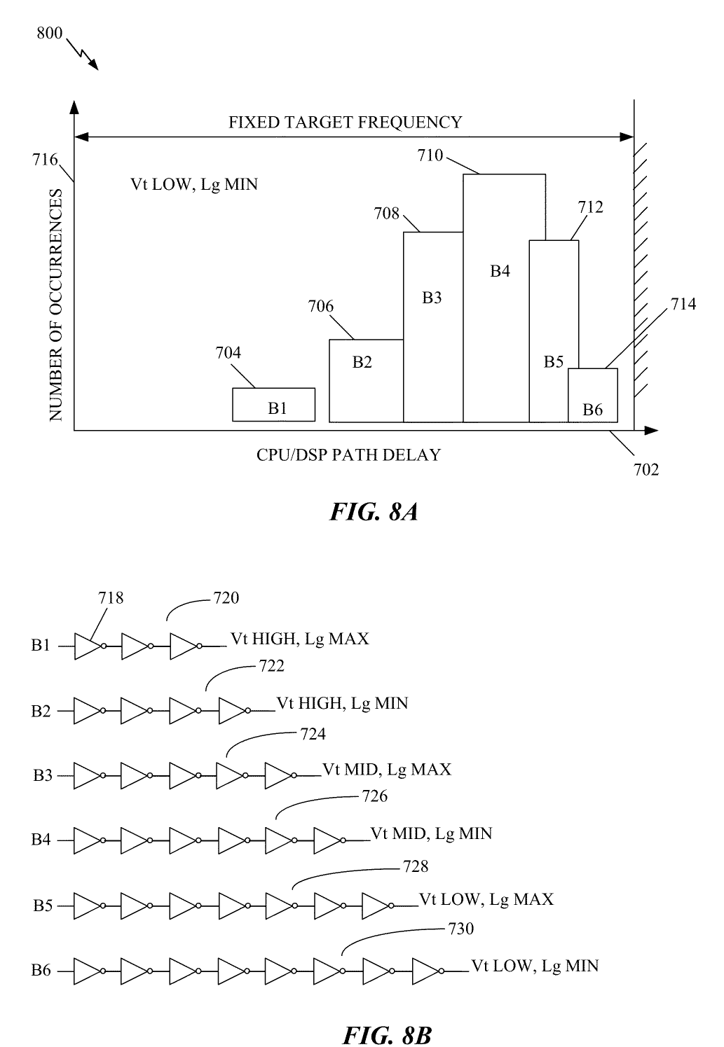

FIGS. 7A-8B illustrate graphical approaches, according to aspects of the present disclosure. In FIG. 7A, a graph 700 indicates data path delays along an x-axis 702. The data path delays, whether for every data path in the SOC or for a representative sample of the data paths in the SOC, are grouped into a first data path bin 704, a second data path bin 706, a third data path bin 708, a fourth data path bin 710, a fifth data path bin 712, and a sixth data path bin 714. In this configuration, each of the data path bins indicates a delay of a certain amount for each data path. For example, in the first data path bin 704, the data paths may have a delay of less than 100 ns. In the second data path bin 706, the data paths may have a delay of between 100 ns and 150 ns. The y-axis 716 indicates the number of occurrences for each data path delay. Each of the data path delays is determined using a specified voltage threshold (Vt) and specified gate length (Lg) for the entire SOC being modeled or tested.

Once the data paths are binned as shown in FIG. 7A, the data path bins (e.g., 704-714) are mapped to specific representative devices, which may be ring oscillators, logic gates, or other devices, shown as modelling blocks 718 in FIG. 7B. Each of the modelling blocks 718 are then placed in series to represent the delay of the paths within that data path bins (e.g., 704-714). Further, each of the modelling blocks 718 uses a certain power to operate, and as such the series representation of each of the data path bins (e.g., 704-714) may have a power weight or value associated with that bin. As such, each of the data path bins (e.g., 704-714) are mapped to a series 720-730 of the modelling blocks 718, with each of the series 720-730 having a power weight or value assigned. This mapping is performed with the same specified Vt and Lg as used in the binning operation of FIG. 7A.

FIG. 8A illustrates graph 800, where the data path bins (e.g., 704-714) of FIG. 7A have been performance enhanced in an aspect of the present disclosure. In FIGS. 8A and 8B, the Vt and Lg of the transistors used in the data paths having delays in each of the data path bins (e.g., 704-714) have been changed to reduce the overall power of the SOC. For example, the data paths in the first data path bin 704 are designed with a higher Vt and a longer Lg than in FIG. 7A, which results in a longer path delay. Nevertheless, the increase in path delay for the data paths in the first data path bin 704 does not appreciably affect the overall speed of the SOC, because the change does not increase the delay in the data paths in the first data path bin 704 past those of the longest data path delay (e.g., in the sixth data path bin 714). This increase in data path delay is, however, offset by a power savings in the overall SOC, which increases the performance and applicability of the SOC. The combinations of Vt and Lg for each of the newly mapped bins are shown in FIG. 8B as series 720-730.

Each of the bins, e.g., 704-714 may further be divided into sub-bins. For example, and not by way of limitation, the data path bins (e.g., 704-714) may each be divided into sub-bins based on one or more physical or electrical characteristics. These electrical characteristics may include an interconnect length, a back end of line resistance, a back end of line capacitance, and a back end of line resistance and capacitance, as well as other parameters to further divide the data path bins (e.g., 704-714).

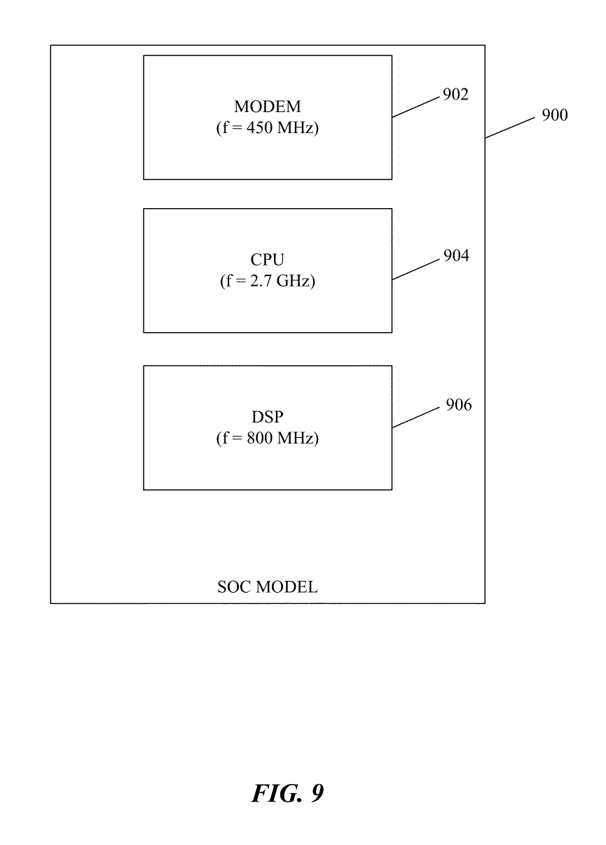

FIG. 9 illustrates a mobile system on chip (SOC) model in accordance with an aspect of the present disclosure. The mobile SOC 900 may include several different components. In the mobile SOC 900, for example, the components may include components 902-906, which may be a modem, a CPU, and/or a DSP, that each operate at different target frequencies and different target power consumptions. In related design technologies, each of the components 902-906 may be designed separately and merely placed on the chip as individual designs with interconnections between the components.

The path delay distribution across the components 902-906, and whether certain data paths within the components 902-906 are critical, non-critical or sub-critical, could vary for each individual one of the components 902-906 based on the circuit topology and architecture. Further, when the components are integrated, some data paths may become critical when connected together, whereas standing alone the data path delays are not as important to the overall system.

As such, one aspect of the present disclosure analyzes and improves the data paths within the mobile SOC 900 for reduced power consumption, or for other design parameters, based on the overall design of the mobile SOC 900, rather than looking at individual one of the component transistor gate lengths and threshold voltages. Further, this aspect of the present disclosure contemplates other design parameters, such as on and off currents, fin lengths and sizes, and other design geometries to the overall design of the mobile SOC 900.

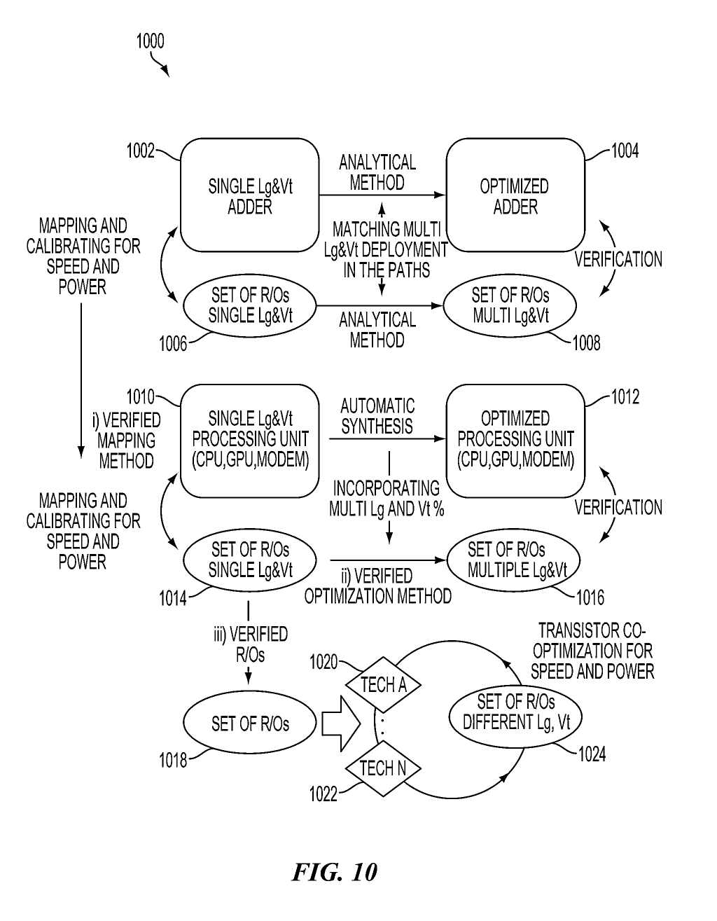

FIG. 10 illustrates a process flow diagram in accordance with an aspect of the present disclosure. Diagram 1000 illustrates an adder circuit 1002, which may be a single gate length/threshold voltage adder circuit, which may be improved directly into an optimized adder circuit 1004. Although described as an adder circuit, other circuits, such as a multiplexer, a multiplier, an inverter, or other circuits, may be used within the scope of the present disclosure. Instead of directly optimizing the adder circuit 1002, the adder circuit 1002 can be binned and mapped according to an aspect of the present disclosure by setting the components and bins in block 1006. In this configuration, each of the data paths of the adder circuit 1002 are binned to a set of bins based on a performance (e.g., speed and/or power) of each of the data paths. Once binned, each bin is mapped to a representative circuit unit data path that is configured according to a predetermined set of electrical and/or physical parameters (e.g., a single gate length and a single threshold voltage). Block 1006 then is analyzed as described with respect to FIGS. 8A-8B to calibrate the set of representative circuit unit data paths according to updated electrical and/or physical parameters to optimize the performance (e.g., speed and/or power) of the set of representative circuit unit data paths in block 1008. In this example, the updated electrical and/or physical parameters are used designed an optimized adder circuit 1004.

The mapping method for the adder circuit 1002 may be applied to a larger portion of the mobile SOC 900, for example the CPU, in design 1010. Similarly, this may be directly improved or optimized into an improved circuit 1012. In this configuration, each of the data paths of the design 1010 are binned to a set of bins based on a performance (e.g., speed and/or power) of each of the data paths. Once binned, each bin is mapped to a representative circuit unit data path that is configured according to a predetermined set of electrical and/or physical parameters (e.g., a single gate length and a single threshold voltage) at block 1014. The improved circuit 1012 may be provided at block 1016 by calibrating the set of representative circuit unit data paths of the design 1010 according to updated electrical and/or physical parameters to optimize the performance (e.g., speed and/or power) of the set of representative circuit unit data paths in the improved circuit 1012.

In block 1018 the set of representative circuit unit data paths of the design that are configured according to the predetermined set of electrical and/or physical parameters (e.g., a single gate length and a single threshold voltage) are applied to different technology nodes. In this configuration, the set of representative circuit unit data paths of the design 1010 are calibrating according to updated electrical and/or physical parameters of the advanced technology node to optimize the performance (e.g., speed and/or power) of the set of representative circuit unit data paths in the advanced technology node at block 1024. The performance of the various different fabrication technologies 1020-1022 are analyzed to determine the advanced technology node that provides the best performance. This allows for performance improvement in the design (e.g., transistor gate length and threshold voltages) throughout the mobile SOC 900 for speed, power, or other desired design characteristics.

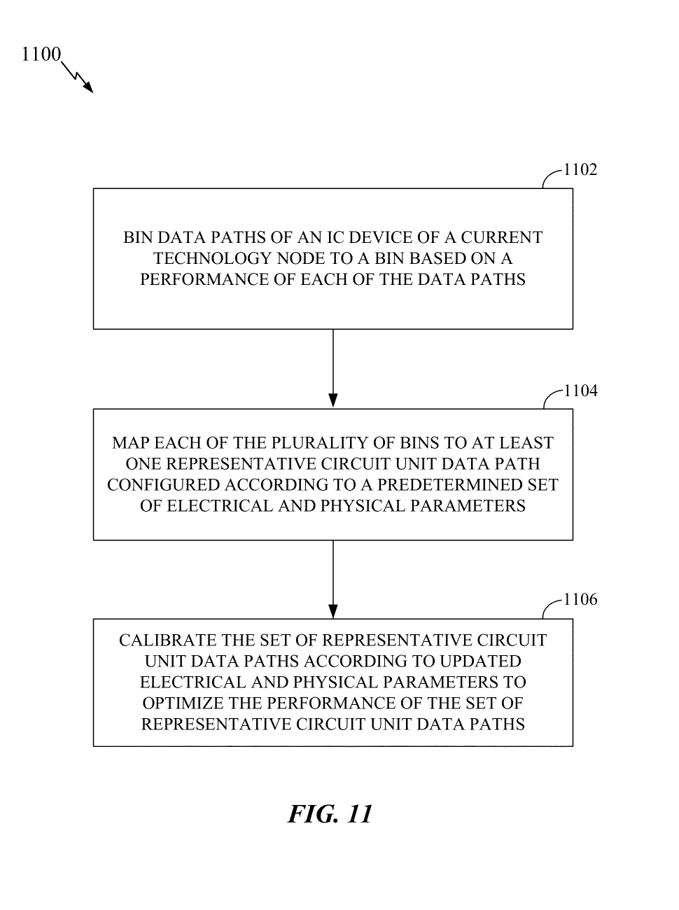

FIG. 11 is a process flow diagram illustrating a method 1100 for fabricating a system on a chip according to an aspect of the present disclosure. In block 1102, data paths of an IC device of a current technology node are binned to a bin based on a performance of each of the data paths. In block 1104, each of the bins are mapped to a representative circuit unit data path. Each representative circuit unit data path is initially configured according to a predetermined set of electrical and/or physical parameters (e.g., a single gate length and a single threshold voltage). In block 1106, the set of representative circuit unit data paths are calibrated according to updated electrical and/or physical parameters to optimize the performance of the set of representative circuit unit data paths. These updated electrical and/or physical parameters may be used to improve the performance of the IC device of an advanced technology node.

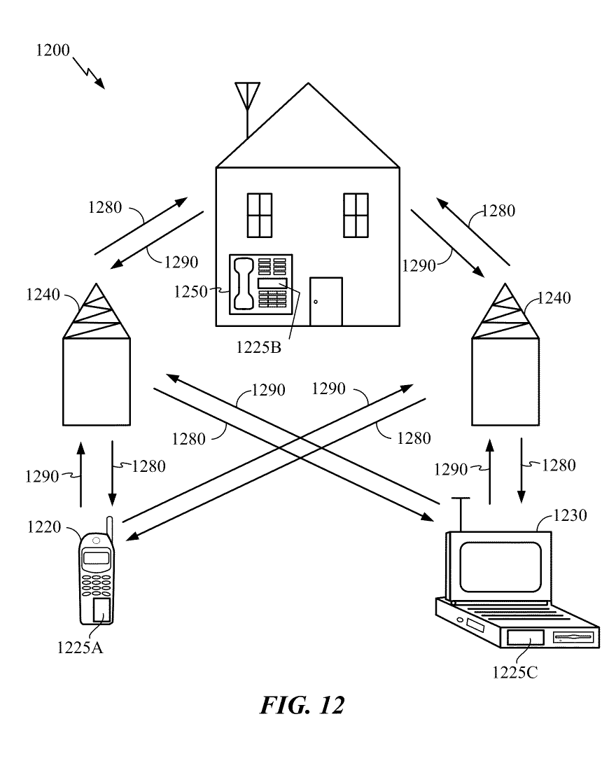

FIG. 12 is a block diagram showing an exemplary wireless communication system 1200 in which an aspect of the disclosure may be advantageously employed. For purposes of illustration, FIG. 12 shows three remote units 1220, 1230, and 1250 and two base stations 1240. It will be recognized that wireless communication systems may have many more remote units and base stations. Remote units 1220, 1230, and 1250 include IC devices 1225A, 1225C, and 1225B that include the disclosed systems on a chip. It will be recognized that other devices may also include the disclosed systems on a chip, such as the base stations, switching devices, and network equipment. FIG. 12 shows forward link signals 1280 from the base station 1240 to the remote units 1220, 1230, and 1250 and reverse link signals 1290 from the remote units 1220, 1230, and 1250 to base stations 1240.

In FIG. 12, remote unit 1220 is shown as a mobile telephone, remote unit 1230 is shown as a portable computer, and remote unit 1250 is shown as a fixed location remote unit in a wireless local loop system. For example, the remote units may be mobile phones, hand-held personal communication systems (PCS) units, portable data units such as personal data assistants, GPS enabled devices, navigation devices, set top boxes, music players, video players, entertainment units, fixed location data units such as meter reading equipment, or other devices that store or retrieve data or computer instructions, or combinations thereof. Although FIG. 12 illustrates remote units according to the aspects of the disclosure, the disclosure is not limited to these exemplary illustrated units. Aspects of the disclosure may be suitably employed in many devices, which include the disclosed devices.

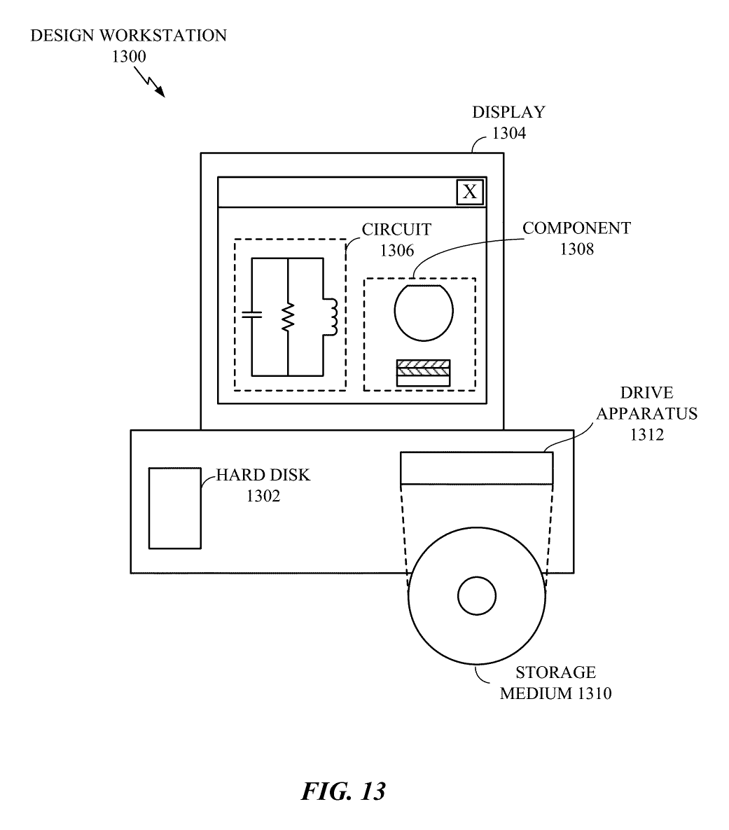

FIG. 13 is a block diagram illustrating a design workstation used for circuit, layout, and logic design of a semiconductor component, such as the devices disclosed above. A design workstation 1300 includes a hard disk 1302 containing operating system software, support files, and design software such as Cadence or OrCAD. The design workstation 1300 also includes a display 1304 to facilitate design of a circuit 1306 or a semiconductor component 1308 such as a system on a chip of the present disclosure. A storage medium 1310 is provided for tangibly storing the design of the circuit 1306 or the semiconductor component 1308. The design of the circuit 1306 or the semiconductor component 1308 may be stored on the storage medium 1310 in a file format such as GDSII or GERBER. The storage medium 1310 may be a CD-ROM, DVD, hard disk, flash memory, or other appropriate device. Furthermore, the design workstation 1300 includes a drive apparatus 1312 for accepting input from or writing output to the storage medium 1310.

Data recorded on the storage medium 1310 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1310 facilitates the design of the circuit 1306 or the semiconductor component 1308 by decreasing the number of processes for designing semiconductor wafers.

In an aspect of the present disclosure, a device for designing an integrated circuit (IC) is described. In one configuration, the device includes means for binning data paths of an IC device of a current technology node to bins based at least in part on a performance of each of the data paths. The binning means may be the design workstation 1300 as shown in FIG. 13. In such a configuration, the device also includes means for each of the bins to a representative circuit unit data path configured according to a predetermined set of electrical and/or physical parameters. The mapping means may be the design workstation 1300 as shown in FIG. 13. The device also includes means for calibrating the set of representative circuit unit data paths according to updated electrical and/or physical parameters to optimize the performance of the set of representative circuit unit data paths to improve the performance of the IC device of an advanced technology node. The calibrating means may be the design workstation 1300 as shown in FIG. 13. In another aspect, the aforementioned means may be any module or any apparatus configured to perform the functions recited by the aforementioned means.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of integrated circuit (IC) technology design, comprising:
binning data paths of an IC device of a current technology node to a plurality of bins based at least in part on a performance of each of the data paths;
mapping each of the plurality of bins to at least one representative circuit unit data path configured according to a predetermined set of electrical and/or physical parameters; and
calibrating a set of representative circuit unit data paths according to updated electrical and/or physical parameters to increase the performance of the set of representative circuit unit data paths to improve the performance of the IC device of an advanced technology node.

2. The method of claim 1, further comprising:
calibrating the set of representative circuit unit data paths according to the updated electrical and/or physical parameters to optimize the performance of the set of representative circuit unit data paths in one or more advanced technology nodes; and
selecting an advanced technology node from one or more advanced technology nodes based at least in part on the performance of the set of representative circuit unit data paths according to the updated electrical and/or physical parameters of the selected advanced technology node.

3. The method of claim 1, in which the updated electrical and/or physical parameters comprise channel length and threshold voltage.

4. The method of claim 1, in which the updated electrical and/or physical parameters comprise intrinsic resistance capacitance (RC), parasitic RC, transistor on/off slope and/or transistor on/off shift.

5. The method of claim 1, in which the updated electrical and/or physical parameters are achieved by physical adjustment of a device structure.

6. The method of claim 1, in which the IC device comprises a central processing unit (CPU), a digital signal processor (DSP) and/or a modem.

7. The method of claim 1, in which the set of representative circuit unit data paths comprises a delay chain or a ring oscillator chain.

8. The method of claim 1, further comprising designing a device and/or process technology based on the updated electrical and/or physical parameters.

9. The method of claim 8, in which the device and/or process technology is designed based at least in part on one or more of a speed, a power consumption, an area scaling complexity, a die size, and a number of masks.

10. The method of claim 1, in which binning comprising assigning each of the data paths into one of the plurality of bins according to a speed and/or power consumption value of the data path within the current technology node.

11. The method of claim 1, further comprising sub-binning with a bin of the plurality of bins according to one or more of an interconnect length, a back end of line resistance, a back end of line capacitance, and a front end of line resistance and capacitance.

12. The method of claim 1, further comprising integrating the IC device into a mobile phone, a set top box, a music player, a video player, an entertainment unit, a navigation device, a computer, a hand-held personal communication systems (PCS) unit, a portable data unit, and/or a fixed location data unit.

13. A device for designing an integrated circuit (IC), comprising:
means for binning data paths of an IC device of a current technology node to a plurality of bins based at least in part on a performance of each of the data paths;
means for mapping each of the plurality of bins to at least one representative circuit unit data path configured according to a predetermined set of electrical and/or physical parameters; and
means for calibrating a set of representative circuit unit data paths according to updated electrical and/or physical parameters to increase the performance of the set of representative circuit unit data paths to improve the performance of the IC device of an advanced technology node.

14. The device of claim 13, further comprising:
means for calibrating the set of representative circuit unit data paths according to the updated electrical and/or physical parameters to optimize the performance of the set of representative circuit unit data paths in one or more advanced technology nodes; and
means for selecting an advanced technology node from one or more advanced technology nodes based at least in part on the performance of the set of representative circuit unit data paths according to the updated electrical and/or physical parameters of the selected advanced technology node.

15. The device of claim 13, in which the updated electrical and/or physical parameters comprise channel length and threshold voltage.

16. The device of claim 13, integrated into a mobile phone, a set top box, a music player, a video player, an entertainment unit, a navigation device, a computer, a hand-held personal communication systems (PCS) unit, a portable data unit, and/or a fixed location data unit.

17. A device for designing an integrated circuit (IC), comprising:
a memory; and
a processor, coupled to the memory, configured:
to bin data paths of an IC device of a current technology node to a plurality of bins based at least in part on a performance of each of the data paths;
to map each of the plurality of bins to at least one representative circuit unit data path configured according to a predetermined set of electrical and/or physical parameters; and
to calibrate a set of representative circuit unit data paths according to updated electrical and/or physical parameters to increase the performance of the set of representative circuit unit data paths to improve the performance of the IC device of an advanced technology node.

18. The device of claim 17, in which the IC is integrated into a mobile phone, a set top box, a music player, a video player, an entertainment unit, a navigation device, a computer, a hand-held personal communication systems (PCS) unit, a portable data unit, and/or a fixed location data unit.

19. A computer program product configured to design an integrated circuit (IC), the computer program product comprising:
a non-transitory computer-readable medium having non-transitory program code recorded thereon, the non-transitory program code comprising:
program code to bin data paths of an IC device of a current technology node to a plurality of bins based at least in part on a performance of each of the data paths;
program code to map each of the plurality of bins to at least one representative circuit unit data path configured according to a predetermined set of electrical and/or physical parameters; and
program code to calibrate a set of representative circuit unit data paths according to updated electrical and/or physical parameters to increase the performance of the set of representative circuit unit data paths to improve the performance of the IC device of an advanced technology node.

20. The computer program product of claim 19, in which the non-transitory program code further comprises:
program code to calibrate the set of representative circuit unit data paths according to the updated electrical and/or physical parameters to optimize the performance of the set of representative circuit unit data paths in one or more advanced technology nodes; and
program code to select an advanced technology node from one or more advanced technology nodes based at least in part on the performance of the set of representative circuit unit data paths according to the updated electrical and/or physical parameters of the selected advanced technology node.

21. The computer program product of claim 19, in which the updated electrical and/or physical parameters comprise channel length and threshold voltage.

22. The computer program product of claim 19, in which the updated electrical and/or physical parameters comprise intrinsic resistance capacitance (RC), parasitic RC, transistor on/off slope and/or transistor on/off shift.

23. The computer program product of claim 19, in which the updated electrical and/or physical parameters are achieved by physical adjustment of a device structure.

24. The computer program product of claim 19, in which the IC device comprises a central processing unit (CPU), a digital signal processor (DSP) and/or a modem.

25. The computer program product of claim 19, in which the set of representative circuit unit data paths comprises a delay chain or a ring oscillator chain.

26. The computer program product of claim 19, in which the non-transitory program code further comprises program code to design a device and/or process technology based on the updated electrical and/or physical parameters.

27. The computer program product of claim 26, in which the device and/or process technology is designed based at least in part on one or more of a speed, a power consumption, an area scaling complexity, a die size, and a number of masks.

28. The computer program product of claim 19, in which the program code to bin comprises program code to assign each of the data paths into one of the plurality of bins according to a speed and/or power consumption value of the data path within the current technology node.

29. The computer program product of claim 19, further comprising sub-binning with a bin of the plurality of bins according to one or more of an interconnect length, a back end of line resistance, a back end of line capacitance, and a front end of line resistance and capacitance.

30. The computer program product of claim 19, further comprising integrating the IC device into a mobile phone, a set top box, a music player, a video player, an entertainment unit, a navigation device, a computer, a hand-held personal communication systems (PCS) unit, a portable data unit, and/or a fixed location data unit.
